(19) United States
(12) Patent Application Publication
(10) Pub. No.: US 2013/0248471 A1
(43) Pub. Date: Sep. 26, 2013

(54) Bin Systems

(71) Applicant: Jeffrey Evans, Portland, OR (US)

(72) Inventor: Jeffrey Evans, Portland, OR (US)

(21) Appl. No.: 13/851,041

(22) Filed: Mar. 26, 2013

Related U.S. Application Data
(60) Provisional application No. 61/615,793, filed on Mar. 26, 2012.

(51) Int. Cl. B65F 1/14; A47F 5/08

(52) U.S. Cl. CPC B65F 1/141; A47F 5/08
USPC 211/71.01; 211/119.003; 211/85.19

(57) ABSTRACT

A bin system including a bin support frame and a bin. The lain support frame for supporting the bin and selectively mounting to a. support member, including a shoulder member, a retaining member, a body member, and a shelf. The shoulder member is configured to selectively secure to the support member. The retainer member projects from the shoulder member and is complimentarily configured with a retainer slot of the bin, wherein selectively inserting the retainer member into the retainer slot of the bin retains the bin on the shoulder member. The body member extends from the shoulder member. The shelf is spaced from the retainer member a distance corresponding to the distance between the retainer slot of the bin and a bottom of the bin. Further, the shelf extends transverse from the body member and is configured to support the bottom of the bin when the bin is retained on the retainer member of the shoulder.

### CROSS REFERENCE TO RELATED APPLICATIONS

This application claims priority to copending U.S. Application Ser. No. 61615793, filed on Mar. 26, 2012, which is hereby incorporated by reference for all purposes.

### BACKGROUND

The present disclosure relates generally to bin systems. In particular, bin systems with integrated frames and sanitary bins are described.

Known bin systems are not entirely satisfactory for the range of applications in which they are employed. For example, existing bin systems are not aesthetically pleasing; therefore, it is most desirable to place known bin systems out of plain sight. Known bin systems require a user to inconveniently store the bin system inside a cabin under a kitchen counter; thus, using current bin systems requires the user to remove the bin from storage prior to using the bin. Removing bins from under-cabinet storage is also inconvenient because a user must stoop below a cabinet when removing the bin from storage and when returning the bin to storage after using the bin.

An additional limitation of known bin systems is that storing the bin under a cabinet requires the bin to be transported to and from the storage location between each use. When using an existing bin system, the bin must be placed at counter height or on the floor. Bins located on a counter or on the floor are not ideal for scraping food scraps from used dishes or cooking utensils into the bin. Indeed, using the bin when located on a counter or on the floor requires hopeful aiming of unwanted compostable food scraps, which often results in messy counter tops or floors, thus requiring additional cleaning.

In addition, unsightly conventional bin systems may be stored in an inconvenient adjacent pantry. Although storing a bin system in a pantry may eliminate the inconvenient stooping required by under-cabinet storage, storing known bin systems in the pantry is even less convenient because known lam systems still must be retrieved before using them. Thus, inconveniently storing bin systems in an adjacent pantry does not eliminate the issues discussed above when actually using known bin systems on either the counter top or floor. Additionally, due to limited space within the pantry area, bin systems may be hidden or packed behind other items. Storing existing bin systems outside of arm's reach leads to the bin systems being used less or not at all.

In addition to being inconveniently located in an adjacent location, storing known bin systems in a pantry s undesirable because consumable food items are stored in the pantry. Storing food to be consumed in the future adjacent to known bin systems containing degrading compostable food scraps is unsanitary and undesirable as known bin systems lack odor control capabilities and are odiferous. Thus, odor causing gaseous particles released from refuse stored within known bin systems often ruin food that would otherwise be consumable.

Thus, there exists a need for bin systems that improve upon and advance the design of known bin systems. Examples of new and useful bin systems relevant to the needs existing in the field are discussed below.

### SUMMARY

A bin system including a bin support frame and a bin. The bin support frame for supporting the bin and selectively mounting to a support member, including a shoulder member, a retaining member, a body member, and a shelf. The shoulder member is configured to selectively secure to the support member. The retainer member projects from the shoulder member and is complimentarily configured with a retainer slot of the bin, wherein selectively inserting the retainer member into the retainer slot of the bin retains the bin on the shoulder member. The body member extends from the shoulder member. The shelf is spaced from the retainer member a distance corresponding to the distance between the retainer slot of the bin and a bottom of the bin. Further, the shelf extends transverse from the body member and is configured to support the bottom of the bin when the bin is retained on the retainer member of the shoulder.

### BRIEF DESCRIPTION OF THE DRAWINGS

FIG. 1 is a perspective view of a first example of a bin system.

FIG. 2 is a perspective view of the bin shown in FIG. 1 depicting the bin with a closed lid.

FIG. 3 is a perspective view of the bin shown in FIG. 1 depicting the bin with an open lid.

FIG. 4 is an exploded view of the bin system shown in FIG. 1 depicting the shelf of the bin support frame.

FIG. 5 is a side elevation view of the bin system shown in FIG. 1 depicting the interaction between the bin and the bin support frame.

FIG. 6 is a cross-section view through the retainer members of the bin support frame shown in FIG. 1 depicting the interaction between the retainer slot of the bin and the retainer members of the bin support frame.

FIG. 7 is a front elevation view of the bin support frame shown in FIG. 1 depicting a cross-section line.

FIG. 8 is a cross-section view of the bin system shown in FIG. 1 depicting the interaction between the bin and the lain support frame.

FIG. 9 is a close-up cross-section view of the interaction between the retainer slot of the bin and the retainer member of the bin support frame.

FIG. 10 is a close-up cross-section view of the interaction between the lip of the bin and the shelf and channel of the bin support frame.

FIG. 11 is an exploded perspective view of a second example of a bin system.

FIG. 12 is a dose-up perspective view depicting the latch of the bin support frame shown in FIG. 11.

FIG. 13 is a front elevation view of the bin support frame shown in FIG. 11 depicting the latch in a rest position with the latch engaged position in dashed lines.

FIG. 14 is a side elevation view of the bin support frame shown in FIG. 11 depicting the channel portion of the shelf.

FIG. 15 is a front elevation view of the bin support frame extension member shown in FIG. 11.

FIG. 16 is a side elevation view of the bin support frame extension member shown in FIG. 11. p FIG. 17 is a from elevation view of the bin support frame shown in FIG. 11 depicting the extension mechanism.

### DETAILED DESCRIPTION

The disclosed bin systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake, of brevity, each and every contemplated variation is not individually described in the following detailed description.

Throughout the following detailed description, examples of various bin systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

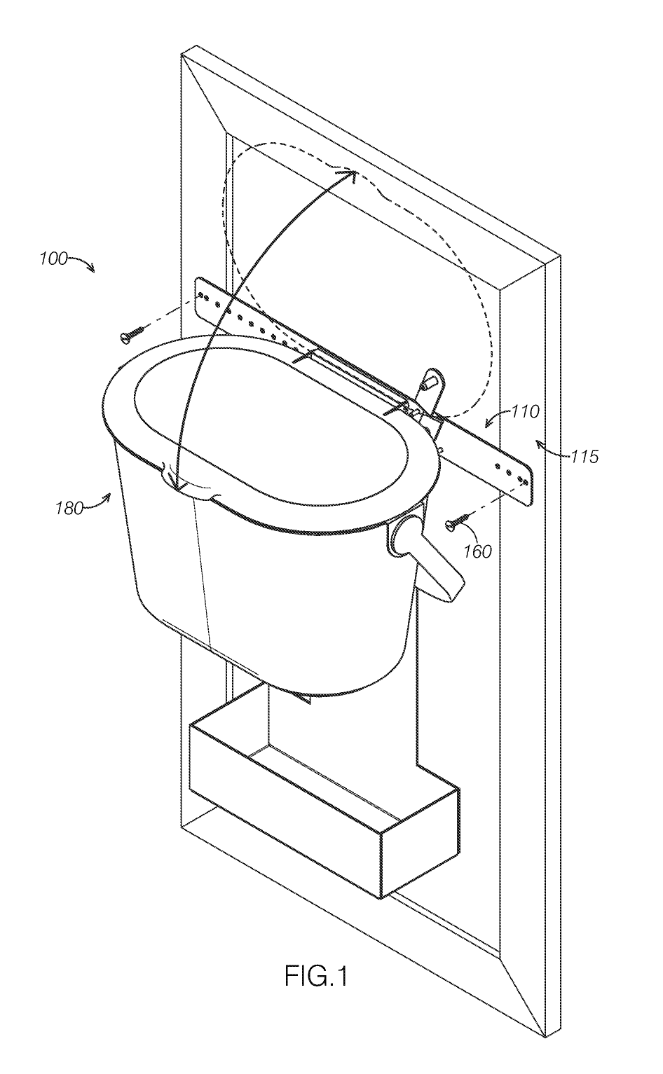

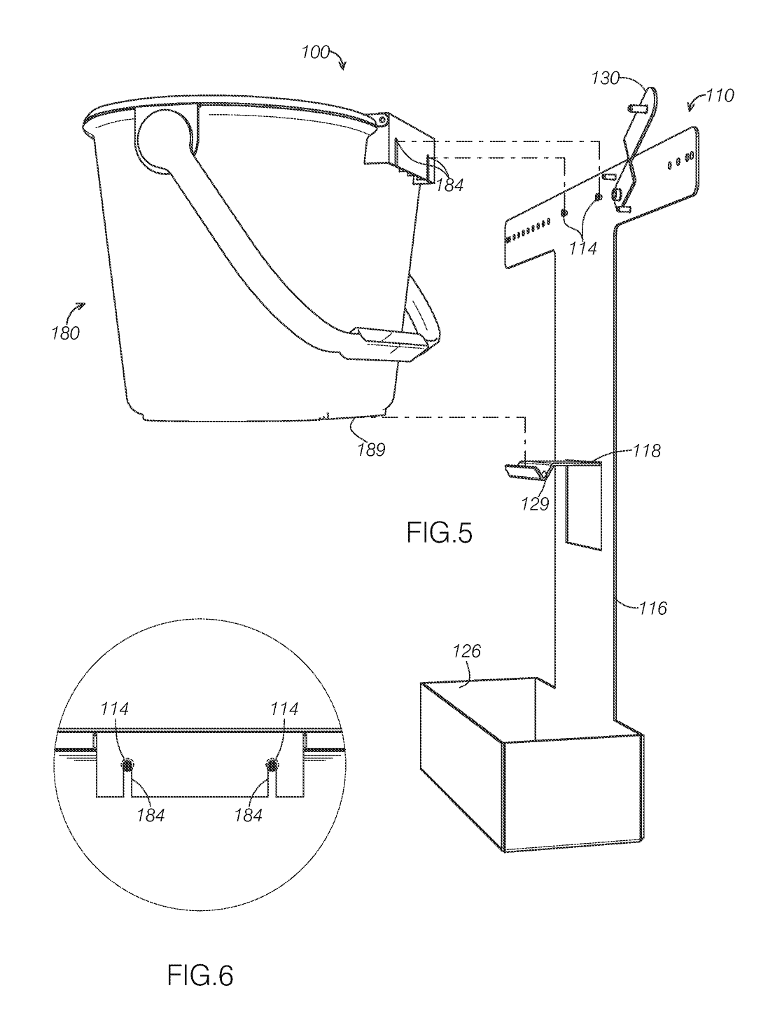

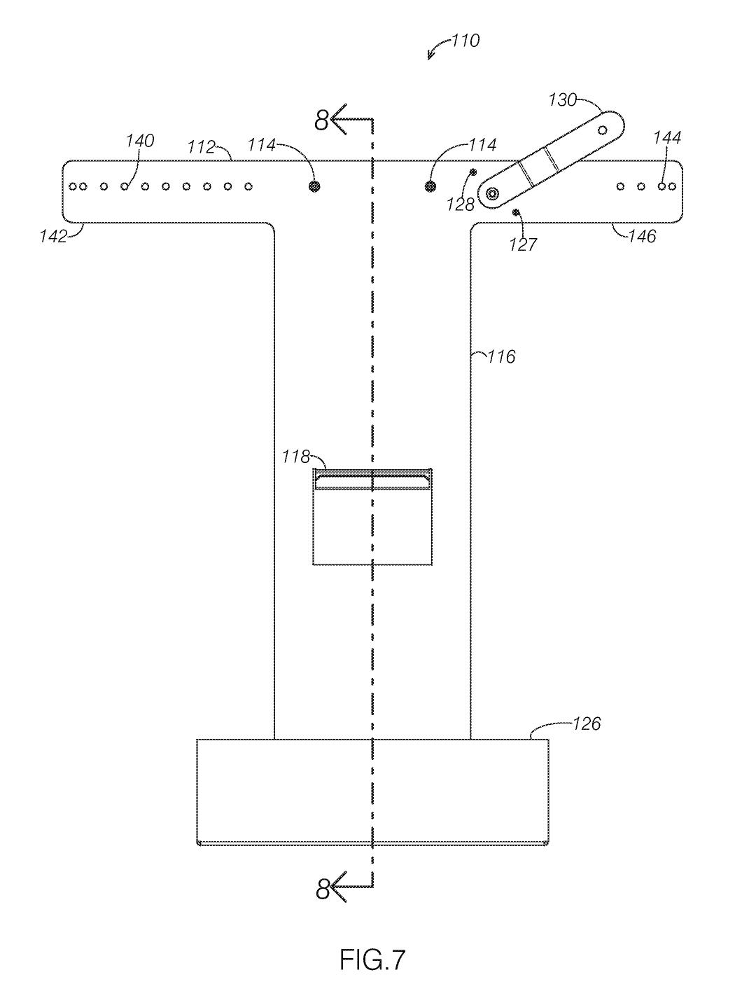

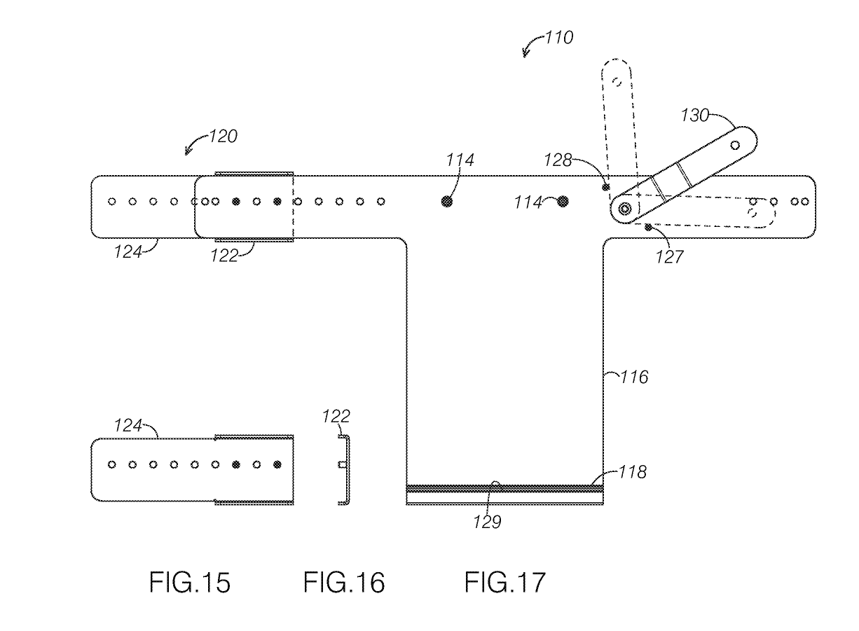

With reference to FIGS. 1-17, a first example of a bin system, bin system 100 will nosy be described. Bin system 100 includes a bin 180, a bin support frame 110, and one or more fasteners 160 configured to selectively couple bin support frame 110 with a support member 115. Bin system 100 may be mounted on the inside of a kitchen cabinet, cabinet exterior, pantry door, or interior wall of a pantry area so that bin system 100 is not in plain sight. Additionally, bin system 100 may be mounted at a height that eliminates stooping when scraping food scraps. In the case of mounting bin system 100 to the inside of a below counter kitchen cabinet, a height may be selected to allow a user to comfortably scrape plates or peel vegetables into bin system 100 without stooping.

In the example shown in FIG. 1, support member 115 is a cabinet door, in other examples, the support member is a variety of rigid vertical surfaces. For example, the support member may be a wall, a cabinet exterior, a closet door, or a vertical shelf member.

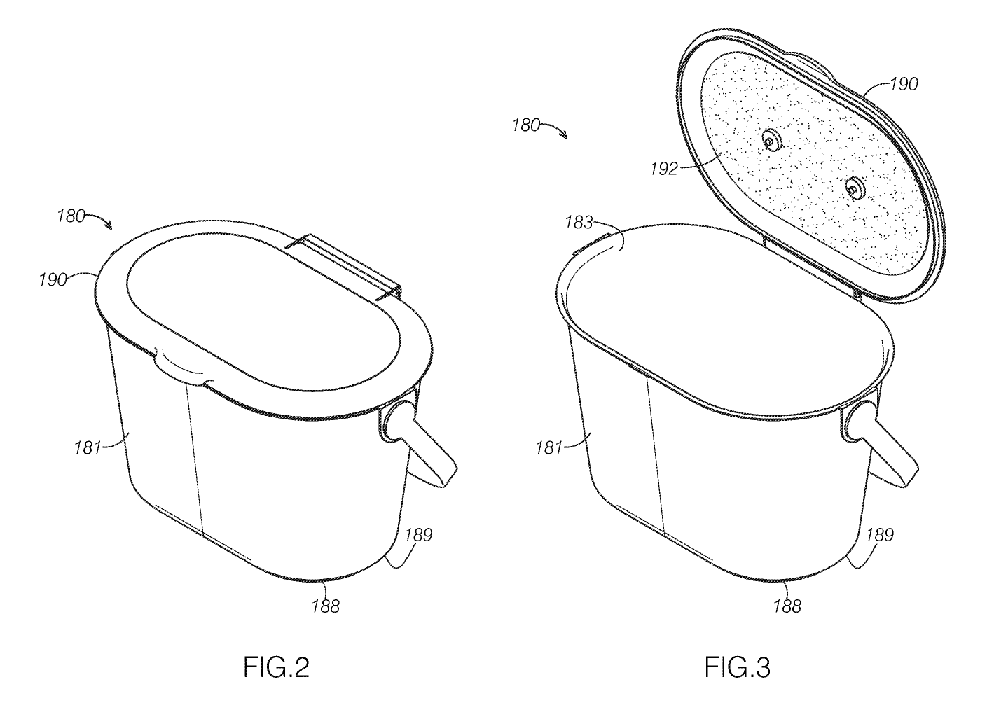

With reference to FIG. 2, bin 180 is made from plastic and is configured to store food refuse for composting. However, the bin may be comprised of any durable, readily sanitizable material including, but not limited to, plastic, metal, wood, or composites. While storing food refuse for composting is an excellent application for bin 180, the bin may be configured to store, any variety of items, including cleaning supplies, tools, household goods, and the like.

As shown in FIG. 2, bin 180 includes a body 181, a lid 190, an activated carbon layer 192, a cavity 183, a bottom 188 including a lip 189, and a retainer slot 184. In some examples, bin 180 is equipped with a handle as shown in FIG. 2. In other examples the bin may be equipped with handle on top of the lid, or on the sides of the body.

As depicted in FIG. 3, body 181 defines cavity 183 for storing refuse. In some examples, body 181 may be configured in any shape that allows maximum cavity 183 volume, but maintains a low-profile design, including, but not limited to cylindrical, ovoid, rectangular, and square. Cavity 183 may accept refuse directly, or be outfitted with lining material to facilitate easy emptying and cleaning of cavity 183. Ideally, cavity 183 lining material be biodegradable, so that the lining material may be removed and disposed with each full cavity 183 volume of refuse; then a new fresh lining may be placed within cavity 183.

Additionally depicted in FIGS. 2-3, lid 190 is configured to selectively cover body 181. Lid 190 is pivotally mounted to body 181, and configured to pivot between a closed position covering cavity 183 and an open position allowing access to cavity 183, in other examples, the lid is not pivotally mounted, but instead attaches to the body by a friction fit and is selectively removable.

Activated carbon layer 192, mounted to lid 190 proximate cavity 183, absorbs odor causing gaseous particles released from refuse stored within cavity 183. Activated carbon layer 192 may be selectively mounted to lid 190 and selectively removed from lid 190. Activated carbon layer 192 may be selectively mounted using any now known or later discovered mounting element including, but not limited to snap-clasp, peg-and-hole, and button.

In the example shown in FIG. 3, activated carbon layer 192 covers substantially all the surface of lid 190 proximate cavity 183. In other examples, the activated carbon layer may be shaped in strips, ovals, rectangles, or circles covering less than substantially all the surface of the lid proximate the cavity.

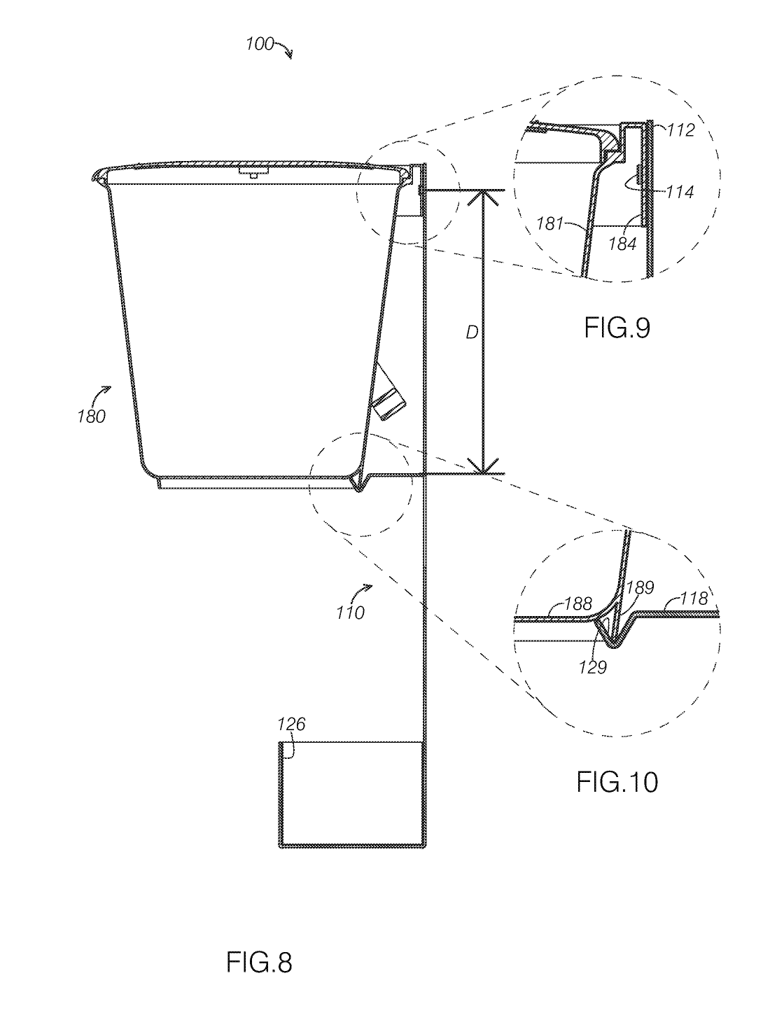

As shown most clearly in FIGS. 5, 6, and 8-10, bin 180 is complimentarily configured with bin support frame 110 such that bin 180 may be quickly and easily mounted within and removed from support frame 110. Bin 180 defines retainer slot 184 and bottom 188 includes lip 189. Retainer slot 184 is complimentarily configured to receive retainer members 114 of bin support frame 110. Shown most clearly in FIG. 8, a distance D between retainer slot 184 of bin 180 and bottom 188 of bin 180 corresponds to complimentarily configured portions of bin support frame 110 to be discussed below.

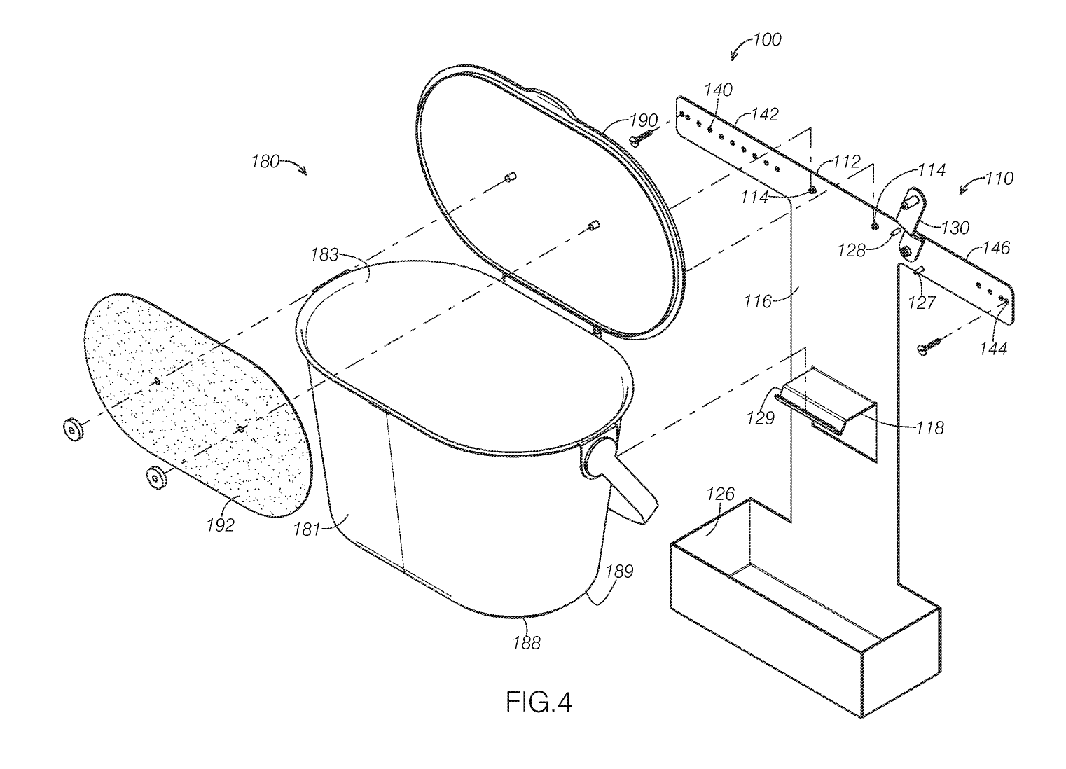

Turning attention to FIG. 4, bin support frame 110 includes a shoulder member 112, a retainer member(s) 114, a body member 116, a shelf 118, a latch 130, a first stop member 127, and a second stop member 128. Bin support frame 110 may also include an extension mechanism 120, as shown in FIG. 11. Likewise, bin support frame 110 may include a tray 126 as depicted in FIG. 4, or may not include the tray as depicted in FIG. 11. Bin support frame 110 is configured to support bin 180 and to selectively mount to support member 115. Bin support frame 110 may be selectively mounted to support member 115 using fastener(s) 160.

Bin support frame 110 is comprised of 16-gauge steel and powder coated to limit or prevent corrosion. In other examples, the bin support frame may be comprised of any rigid durable material including wood, plastics, biodegradable plastics, metals, and composites. In the case of metal bin support frames, an anti-corrosion coating may be applied to prolong the bin support frame's usable life.

Additionally, body member 116 extends from shoulder member 112 and shelf 118 extends transverse from body member 116. Shelf 118 is spaced from retainer member 114 a distance D corresponding to the distance between retainer slot 184 of bin 180 and bottom 188 of bin 180. Shelf 118 is configured to support the bottom of bin 180 when bin 180 is retained on retainer member 114 of shoulder member 112.

Shoulder member 112 is configured to selectively secure bin support frame 110 to support member 115. Shoulder member 112 includes a lateral portion 142, defining a plurality of laterally spaced mounting holes 140, and a second lateral portion 146 defining a second mounting hole 144. As shown in FIG. 11, second lateral portion 146 includes additional, optional mounting holes beyond second mounting hole 144. The plurality of laterally spaced mounting holes 14 and second mounting hole 142 are each configured to receive a fastener 160 to enable shoulder member 112 to be selectively secured to support member 115 with fastener 160 at a plurality of lateral positions along shoulder member 112.

As depicted in FIG. 17, extension mechanism 120 is movingly coupled to shoulder member 112 and configured to selectively extend an effective lateral reach of bin support frame 110. Extension mechanism 120 includes a bracket 122, slidingly mounted to shoulder member 112, push-tab retaining elements, and an extension member 124 extending from bracket 122.

Thus, extension mechanism 120 is configured to slide to different positions along shoulder member 112 to extend a selected portion of extension member 124 beyond shoulder member 112 to selectively extend the effective lateral reach of bin support frame 110. By selectively extending the effective lateral reach of bin support frame 110, extension mechanism 120 facilitates mounting bin support frame 110 on a multitude of support members 115.

As depicted in FIG. 11, push-tab retaining elements 123 secure extension member 124 to shoulder member 112. In further examples, the extension member may be secured to the shoulder member using straps, channel-peg, or clamp-style retaining elements.

Retainer members 114 project from shoulder member 112. Retainer members 114 are complimentarily configured with retainer slots 184 of bin 180. Selectively inserting retainer members 114 into retainer slots 184 of bin 180 retains bin 180 on shoulder member 112.

As shown most clearly is FIG. 11, shelf 118 defines a channel 129. Channel 129 is complimentarily configured with lip 189 on bottom 188 of bin 180 to mate with lip 189 when supporting bottom 188 of bin 180. In other examples, the shelf may be flat and the bottom of the bin also flat such that the bottom of the bin simply rests on top of the shelf when the bin is secured on the retaining elements. In still further examples the shelf may define a square-bottom, or U-bottom channel complimentarily configured to receive the bottom lip of the bin when the bin is secured on the retaining elements.

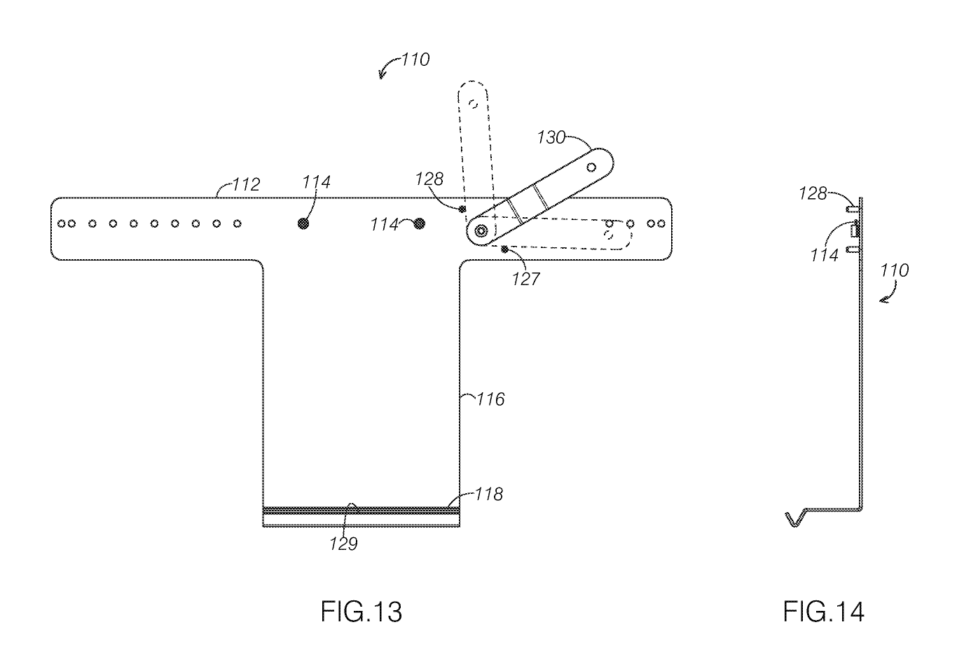

As can be seen in FIGS. 11-13, latch 130 is mounted to shoulder member 112 proximate bin 180 when bin 180 is supported by bin support frame 110. Latch 130 is configured to selectively move between a rest position, shown in dashed lines abutting first stop member 127 in FIG. 13, and an engaged position, also shown in dashed lines abutting second stop member 128 in 13. Latch 130 abuts lid 190 of bin 180 and retains lid 190 in an open position when bin 180 is retained on shoulder member 112 and lid 190 is in the open position.

Latch 130 is pivotally mounted to shoulder member 112. Second stop member 128 projects from shoulder member 112, adjacent latch 130, to abut latch 130 when latch 130 is in the engaged position. First stop member 127 projects from shoulder member 112, adjacent latch 130, to abut latch 130 when latch 130 is in the rest position. In the example shown in FIG. 13, latch 130 is pivotally mounted to shoulder member 112. In other examples, the latch is slidingly or swingingly mounted to the shoulder member to retain the lid in an open position when the latch is in an engaged position.

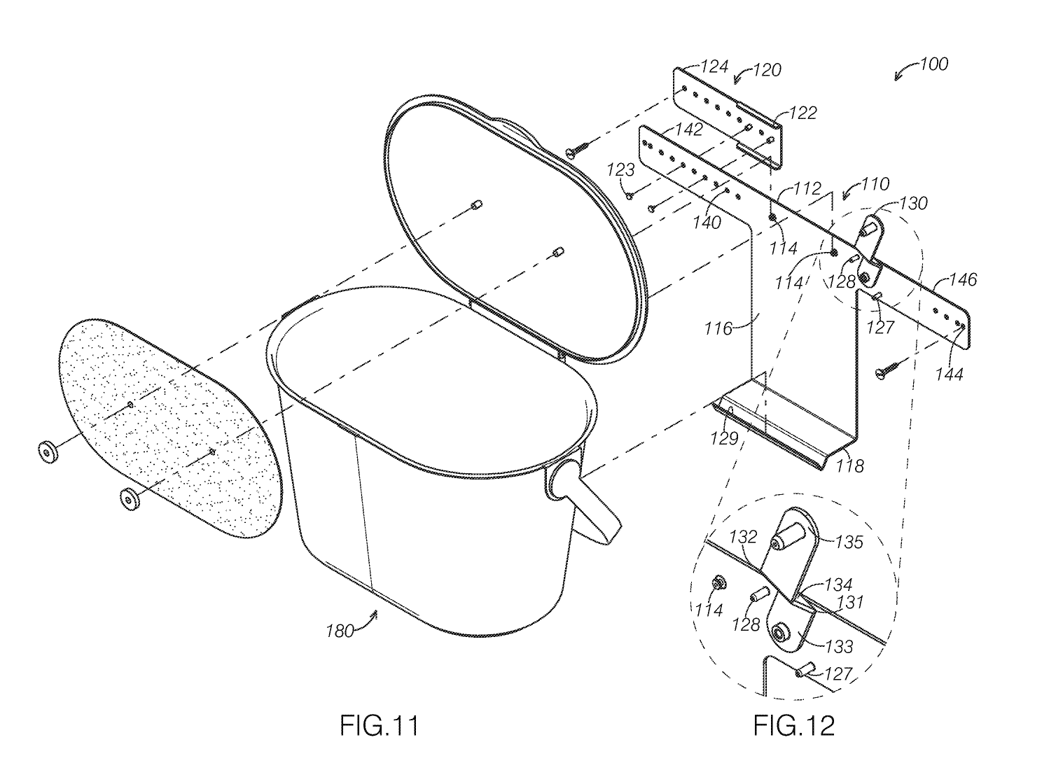

As shown in FIG. 12, latch 130 is bent at two positions, a first bend 131 and a second bend 132, to define a first portion 133, a second portion 134, and a third portion 135. First portion 133 is proximate shoulder member 112 and second portion 134 is opposite first bend 131 from first portion 133. Second portion 134 extends transverse to first portion 133, and third portion 135 opposite second bend 132 from second portion 134, extends transverse to second portion 134. In the current example, latch 130 has the shape of a lightning bolt or a stretched-S; thus, first portion 133 and third portion 135 of latch 130 extend in substantially parallel planes. In other examples the latch may be flat, hooked, or arced.

The disclosure above encompasses multiple distinct inventions with independent utility. While each of these inventions has been disclosed in a particular form, the specific embodiments disclosed and illustrated above are not to be considered in a limning sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring; nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. in support frame configured to support a bin and to selectively mount to a support member, comprising:
a shoulder member configured to selectively secure to the support member;
a retainer member projecting from the shoulder member and complimentarily configured with a retainer slot of the bin, wherein selectively inserting the retainer member into the retainer slot of the bin retains the bin on the shoulder member;
a body member extending from the shoulder member; and
a shelf spaced from the retainer member a distance corresponding to the distance between the retainer slot of the bin and a bottom of the bin, the shelf extending transverse from the body member configured to support the bottom of the tin when the bin is retained on the retainer member of the shoulder member.

2. The bin support frame of claim 1, further comprising an extension mechanism movingly coupled to the shoulder member and configured to selectively extend an effective lateral reach of the bin support frame.

3. The bin support frame of claim 2, wherein the extension mechanism includes:
a bracket slidingly mounted to the shoulder member; and
an extension member extending from the bracket;
wherein the extension mechanism is configured to slide to different positions along the shoulder member to extend a selected portion of the extension member beyond the shoulder member to selectively extend the effective lateral reach of the bin support frame.

4. The bin support frame of claim 1, further comprising a tray supported by the body member.

5. The bin support frame of claim 1 further comprising a latch mounted to the shoulder member proximate the bin when the bin is supported by the bin support frame, the latch configured to selectively move between a rest position and an engaged position, where the latch abuts a lid of the bin and retains the lid in an open position when the bin is retained on the shoulder member and the lid is in the open position.

6. The bin support frame of claim 5, wherein the latch is pivotally mounted to the shoulder member.

7. The bin support frame of claim 6, further comprising a stop member projecting from the shoulder member adjacent the latch to abut the latch when the latch is in the engaged position.

8. The bin support frame of claim 5, wherein the latch is bent at two positions, a first bend and a second bend, to define:
a first portion proximate the shoulder member;
a second portion opposite the first bend from the first portion and extending transverse to the first portion; and
a third portion opposite the second bend from the second portion and extending transverse to the second portion.

9. The bin support frame of claim 8, wherein the first portion and the third portion extend in substantially parallel planes.

10. The bin support frame of claim 1, wherein the shoulder defines a plurality of laterally spaced mounting holes configured to receive a fastener to enable the shoulder to be selectively secured to the support member with the fastener at a plurality of lateral positions along the shoulder.

11. The bin support frame of claim 10, wherein the plurality of laterally spaced mounting holes are defined on a first lateral portion of the shoulder member and the shoulder defines a second mounting hole on a second lateral portion opposite the first lateral portion.

12. The bin support frame of claim 1, wherein the shelf includes a channel complimentarily configured with a lip on the bottom of the bin to mate with the lip when supporting the bottom of the bin.

13. A bin system configured to mount to a support member, comprising:
a bin including:
a bottom; and
a retainer slot; and
a bin support frame configured to selectively secure to the support member and to support the bin, the bin support frame including:
a shoulder member configured to selectively secure to the support member;
a retainer member projecting from the shoulder member and complimentarily configured with the retainer slot of the bin, wherein selectively inserting the retainer member into the retainer slot of the bin retains the bin on the shoulder member;
a body member extending from the shoulder member; and
a shelf spaced from the retainer member a distance corresponding to the distance between the retainer slot of the bin and the bottom of the bin, the shelf extending transverse from the body member and configured to support the bottom of the bin when the bin is retained on the retainer member of the shoulder member.

14. The bin system of claim 13, wherein the bin includes:
a body defining a cavity store refuse;
a lid configured to selectively cover the body; and
an activated carbon layer mounted to the lid proximate the cavity to absorb odor causing gaseous particles released from refuse stored within the cavity.

15. The bin system of claim 13, wherein:
the bin includes:
a body defining a cavity; and
a lid pivotally mounted to the body and configured to pivot between a closed position covering the cavity and an open position allowing access to the cavity; and
the bin support frame includes a latch mounted to the shoulder member proximate the retaining member, the latch configured to selectively move between a rest position and an engaged position, where the latch abuts the lid of the bin and retains the lid in the open position when the bin is retained on the shoulder member and the lid is in the open position.

16. The bin system of claim 15, wherein the latch is pivotally mounted to the shoulder member and pivots between the rest position and the engaged position.

17. The bin system of claim 15, wherein:
the shoulder member defines a plurality of laterally spaced mounting holes on a first lateral portion of the shoulder portion;
the shoulder member defines a second mounting hole on a second lateral portion of the shoulder member opposite the first lateral portion; and
the plurality of laterally spaced mounting holes and the second mounting hole are each configured to receive a fastener to enable the shoulder to be selectively secured to the support member with the fastener at a plurality of lateral positions along the shoulder member.

18. A bin system configured to mount to a support member, comprising:
a bin including:
a body defining a cavity to Store refuse and having a bottom;
a lid configured to selectively cover the body; and
an activated carbon layer mounted to the lid proximate the cavity to absorb odor causing gaseous particles released from refuse stored within the cavity; and
a bin support frame configured to selectively secure to the support member and to support the bin, the bin support frame including:
a shoulder member configured to selectively secure to the support member;
a body member extending from the shoulder member; and
a shelf extending transverse from the body member and configured to support the bottom of the body of the bin.

19. The bin system of claim 18, wherein:
the lid is pivotally mounted to the body and configured to pivot between a closed position covering the cavity and an open position allowing access to the cavity; and
the bin support frame includes a latch mounted to the shoulder member, the latch configured to selectively move between a rest position and an engaged position, where the latch abuts the lid of the bin and retains the lid in the open position when the is retained on the shoulder member and the lid is in the open position.

20. The bin system of claim 18, wherein the activated carbon layer is selectively mounted to the lid and selectively removable from the lid.
